(19) United States
(12) Patent Application Publication
(10) Pub. No.: US 2007/0200318 A1
(43) Pub. Date: Aug. 30, 2007

(54) Air bag door

(75) Inventor: Kazunori Kamiya, Kariya (JP)

Correspondence Address: KODA & ANDROLIA, 2029 CENTURY PARK EAST, SUITE 1140, LOS ANGELES, CA, 90067, US

(73) Assignee: INOAC CORPORATION

(21) Appl. No.: 11/709,598

(22) Filed: Feb. 22, 2007

(30) Foreign Application Priority Data
Feb. 24, 2006 (JP) 2006-48915

(51) Int. Cl. B60R 21/215

(52) U.S. Cl. 280/728.3

(57) ABSTRACT

An air bag door ensures smoother inflation of an air bag. The air bag door has a groove portion of a predetermined depth serving as a predetermined break portion and provided at the peripheral edge of a door panel provided at a base of an instrument panel. The first groove portion extending at the boundary between the base and the door panel has side wall surfaces defining the base side of the first groove portion. The side wall surfaces are obliquely formed in such a way as to come away outward from the door panel as the groove portion extends toward a bottom portion from an open end opening at the back side of the base. The predetermined break portion provided at the bottom portion of the first groove portion is positioned outward of a base-side corner portion of the open end.

### BACKGROUND OF THE INVENTION

1. Field of the Invention

The present invention relates to an air bag door, and, more particularly, to an air bag door having a groove portion of a predetermined depth serving as a predetermined break portion provided and extending at the peripheral edge of a door panel provided on a base of an interior part for a vehicle.

2. Description of the Related Art

A vehicle or the like is equipped with an air bag apparatus for protecting a passenger inside. As shown in FIG. 4, for example, an air bag apparatus 50 for a passenger seat is accommodated in an instrument panel (interior part for vehicle) 10 installed in the front part of a cabin. Therefore, door panels 14, 14 of an air bag door AD1 which opens toward the cabin are provided on a base 12, constituting the instrument panel 10, are formed at positions corresponding to the air bag apparatus 50.

The door panels 14, 14 normally constitute the designed surface of the base 12 as a part thereof. When the air bag apparatus 50 is activated, however, the pressure of an air bag 52 is applied to the door panels 14, 14, rupturing a predetermined break portion 20, so that the door panels 14, 14 are separated from the base 12 and opened. The predetermined break portion 20 is a fragile portion of the base 12, which is formed thin by a groove 18 formed in the direction of the normal line (thickness direction) from the back side of the base 12 (see FIG. 6A). When the door panels 14, 14 are opened, the air bag 52 are inflated into the cabin via an air bag opening 16 formed in the base 12 (see FIG. 4 and FIG. 5B). Because of a short period of about 1/100 second from the initiation of the inflation of the air bag 52 to completion of the inflation, it is important that the door panels 14, 14 do not interfere with the instantaneous inflation of the air bag 52.

In case of the double-swing type air bag door AD1 shown in FIG. 5, the predetermined break portion 20 includes at least distal-end predetermined break portion 22 provided along distal-end edges 14a, 14a of both door panels 14, 14, and side-edge predetermined break portions 24, 24 respectively provided along corresponding side-end edges 14b, 14b of the door panels 14, 14. In the air bag door AD1 whose door panels 14, 14 open while being separated from the base 12, proximal-end predetermined break portions 26, 26 are provided along proximal-end edges 14c, 14c of the door panels 14, 14, which serve as hinge sides when the door panels 14, 14 open. The proximal-end predetermined break portions 26, 26 are provided contiguous to the end portions of both side-end predetermined break portions 24, 24 and in parallel to the distal-end predetermined break portion 22 (see FIG. 5A).

A cylindrical part 42 of a backup member 40 coupled to the air bag apparatus 50 is disposed at the back of the base 12 in such a way as to surround the air bag opening 16. The backup member 40 supports the door panels 14, 14 at the back by means of door supports 44 connected via hinge portions 46 to the cylindrical part 42. The backup member 40 supports the door panels 14, 14 and the peripheries of the air bag opening 16 of the base 12 in a reinforcing manner, thus preventing the door panels 14, 14 and the peripheries of the air bag opening 16 from being damaged by enormous energy which is discharged instantaneously by the inflation of the air bag 52.

The air bag door AD1 is so designed as to break a bottom 18a of the groove 18 in the base 12 (the remaining portion of the base 12 at the time of forming the groove 18) as the predetermined break portion 20 when the air bag apparatus 50 is activated. When the door panel 14 is opened about the proximal-end edge 14c in the air bag door AD1, force applied to the base 12 by the pressure of the air bag 52 may act obliquely (outward). This may cause stress to be concentrated at the bottom corner portions of the groove 18 constituting the side-end predetermined break portions 24, 24, so that the predetermined break portion 20 does not actually break at the bottom 18a of the groove 18 but breaks-with a part of the base 12 obliquely removed sideward from midways of the side-end predetermined break portions 24, 24 (see FIG. 6B). That is, the removed part of the base 12 is likely to remain as a burr 12a on the side-end edge 14b of the door panel 14 which has not been adequately broken along the side-end predetermined break portion 24 (see FIG. 5B or FIG. 6B). Because of a variation in the break position, the air bag door AD 1 may not break adequately, thus requiring large energy to open the door panels 14, 14.

As shown in FIG. 7, therefore, an approximately V-shaped groove 19 is formed by cutting with a milling cutter in the base 12 to provide a fragile portion in this base 12 (see Japanese Patent Laid-Open Publication No. 2005-178451). This air bag door AD2 is designed to concentrate stress to the predetermined break portion 20 provided at a pointed bottom 19a of the V-shaped groove 19 when the door panels 14, 14 are opened. According to the air bag door AD2, however, a part of the base 12 (hatched portion in FIG. 7B) may protrude inward from an opening edge 16a of the air bag opening 16 and remain, and a break surface 12b of the base 12 may protrudes inward of the air bag opening 16. Accordingly, the air bag 52 inflates while rubbing against the remaining portion of the base 12 and the break surface 12b of the base 12. In addition, a distance S between the bottom 19a of the groove 19 which becomes the point of action when the door panels 14, 14 are opened and the cylindrical part 42 that supports the periphery of the air bag opening 16 which becomes the point of support when the door panels 14, 14 are opened becomes wide due to the necessity of forming the groove 19 in an approximately V shape. This disperses stress to be applied when the air bag is opened.

### SUMMARY OF THE INVENTION

To overcome the inherent problems of the conventional air bag doors, therefore, it is an object of the present invention to provide an air bag door which ensures adequate opening of a door panel and smooth inflation of an air bag.

To achieve the object, an air bag door according to one aspect of the invention comprises:

a base of an interior part for a vehicle;

a door panel provided at the base; and

a groove portion of a predetermined depth serving as a predetermined break portion provided and extending at a peripheral edge of the door panel,

wherein the groove portion extending at a boundary between the door panel and the base has side wall surfaces defining a base side obliquely formed in such a way as to come away outward from the door panel as the groove portion extends from an open end side at a back side of the base towards a closed end, and

the predetermined break portion provided at the closed end is configured so as to be positioned outward of a base-side corner portion of the open end.

According to this aspect, as the base-side side wall surfaces of the groove portion are formed obliquely toward the closed end side from the open end side, the opening edge of the air bag opening formed in the base can be so inclined as to spread in the inflating direction of the air bag. The predetermined break portion provided at the closed end of the groove portion is so structured as to be positioned outward of the base-side corner portions of the opening end of the groove portion, so that the base-side break surface which is formed by breakage of the predetermined break portion can be positioned outward of the opening edge of the air bag opening. At the time of inflating the air bag, therefore, the opening edge of the air bag opening and the base-side break surface can be prevented from contacting the air bag, thus ensuring smooth inflation of the air bag.

According to the second aspect of the invention, the predetermined break portion is positioned at a same position as or outward of a door-panel side end portion of a fixing portion which fixes the base and a reinforcing member surrounding the door panel at the back side of the base.

As the groove portion is formed inclined outward, the closed end of the predetermined break portion is provided on the reinforcing member side, so that the predetermined break portion which becomes the point of action when the door panel is opened can be made closer to the fixing portion of the base, which becomes the point of support when the door panel is opened, to the reinforcing member. That is, dispersion of the stress to be applied to the predetermined break portion can be suppressed. Further, the predetermined break portion is positioned at the same position as or outward of the door-panel side end portion of the fixing portion which fixes the base and the reinforcing member, allowing the predetermined break portion and the end portion of the fixing portion to be arranged close to each other. This can further suppress dispersion of stress. At the time the door panel is opened, therefore, stress can be concentrated on the predetermined break portion to adequately break the predetermined break portion.

According to the third aspect of the invention, the closed end of the groove portion obliquely extends with respect to a corresponding portion at a face side of the door panel.

As the closed end of the groove portion is so formed as to obliquely extend with respect to the corresponding face side portion of the door panel, the predetermined break portion can be provided at a corner portion defined by the base-side side wall surface of the groove portion and the closed end or at a corner portion defined by the door-panel-side side wall surface of the groove portion and the closed end. That is, provision of the predetermined break portion at the corner portion of the closed end of the groove portion can permit stress to be concentrated on the predetermined break portion when the door panel is opened, so that the door panel can be adequately broken away from the base at the predetermined break portion.

According to the fourth aspect of the invention, the side wall surfaces defining the base side of the groove portion are inclined within a range of 50 to 45° with respect to a normal line of the base.

Setting the inclination angle of the groove portion within a predetermined range can ensure more adequate breakage at the predetermined break portion.

### BRIEF DESCRIPTION OF THE DRAWINGS

FIG. 1 is a side cross-sectional view of an interior part for a vehicle where an air bag door according to a preferred embodiment of the present invention is provided;

FIG. 2 is an enlarge diagram of a part A in FIG. 1 showing a state before door panels are opened;

FIG. 3 is a side cross-sectional view showing an essential portion when the door panels are opened;

FIG. 4 is a side cross-sectional view of an interior part for a vehicle where a conventional air bag door is provided;

FIGS. 5A and 5B are front views of the conventional air bag door, respectively showing a state before door panels are opened and a state when the door panels are opened;

FIGS. 6A and 6B are side cross-sectional views showing a part of the interior part for a vehicle in enlargement, FIG. 6A showing a state before door panels are opened while FIG. 6B shows a state when the door panels are opened; and

FIGS. 7A and 7B are side cross-sectional views of an interior part for a vehicle where another conventional air bag door is provided, FIG. 7A showing a state before door panels are opened while FIG. 7B shows a state when the door panels are opened.

### DETAILED DESCRIPTION OF THE PREFERRED EMBODIMENT

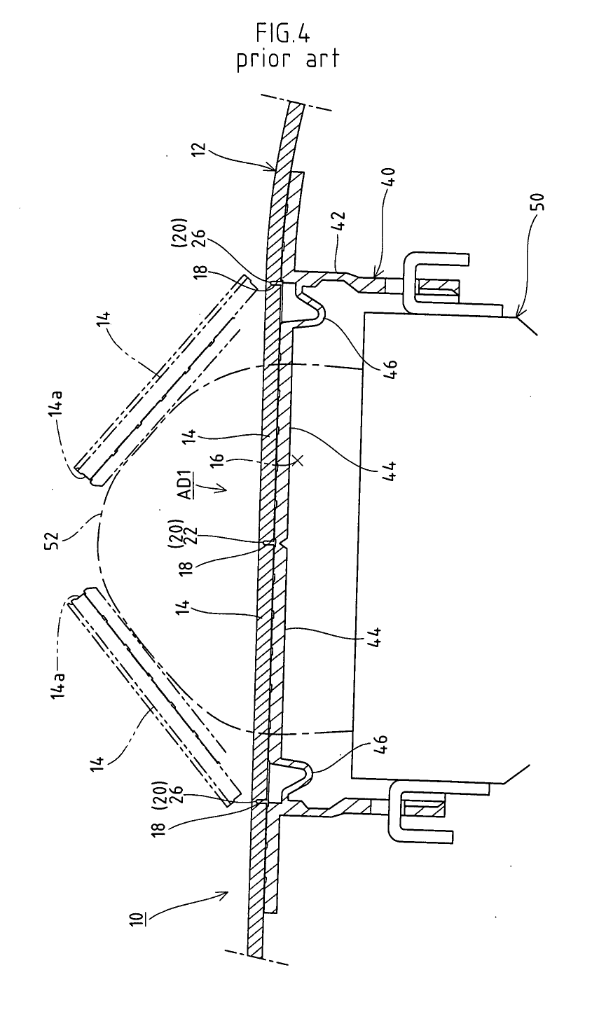

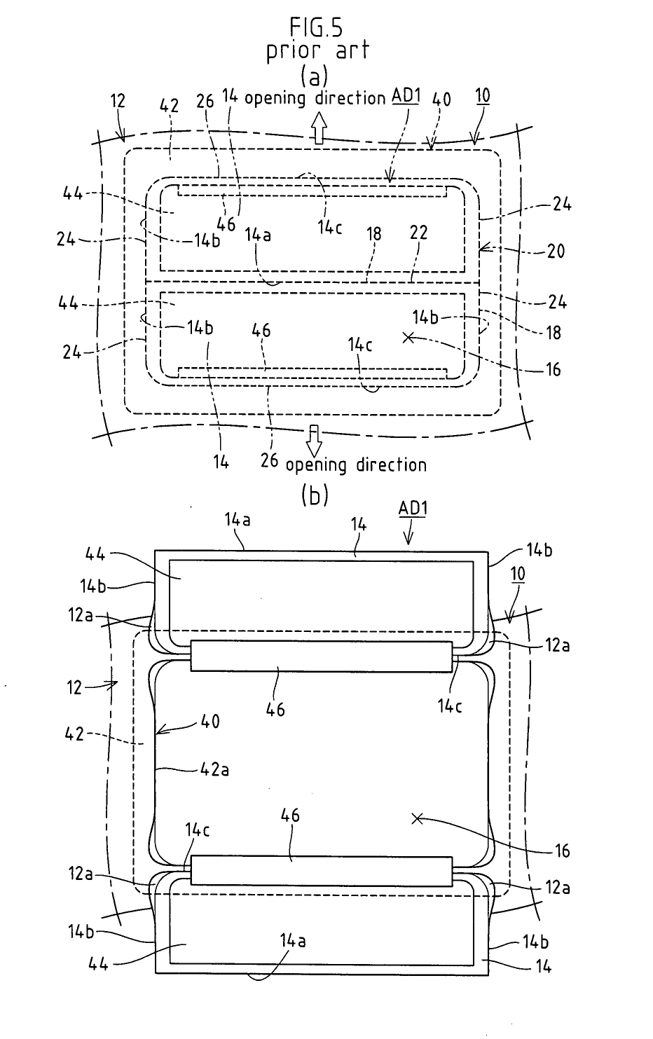

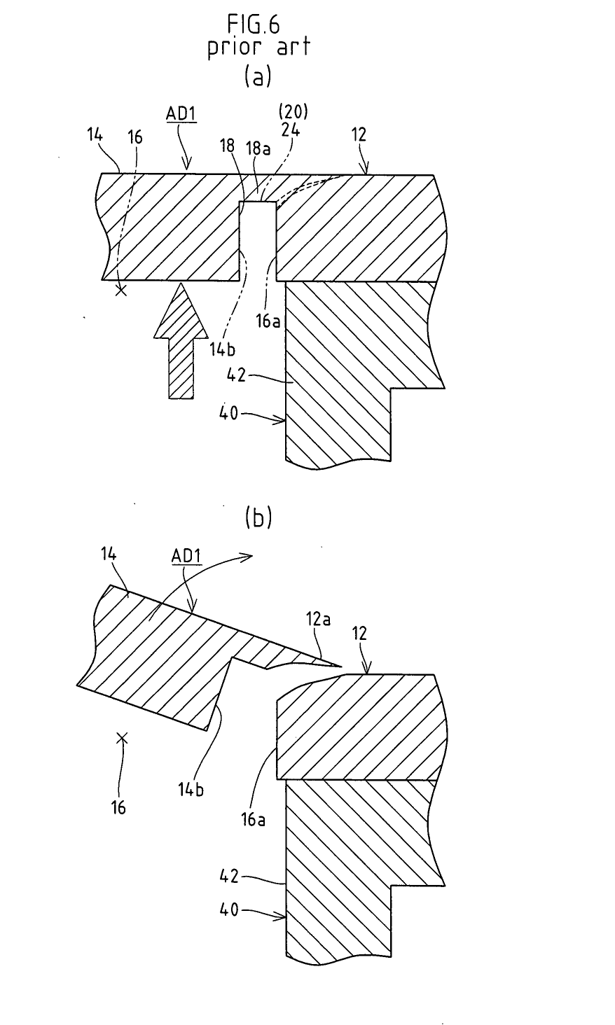

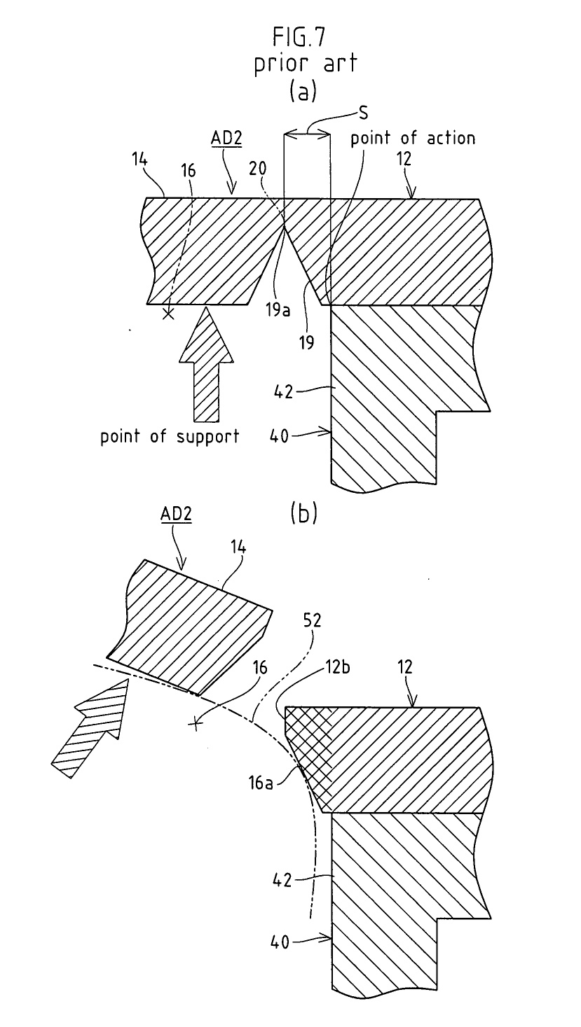

An air bag door according to a preferred embodiment of the present invention will be described below referring to the accompanying drawings. For the sake of descriptive convenience, same reference numerals are given to those components which are similar or identical to those of the air bag door shown in FIGS. 4 to 7 to avoid their redundant detailed descriptions.

### Embodiment

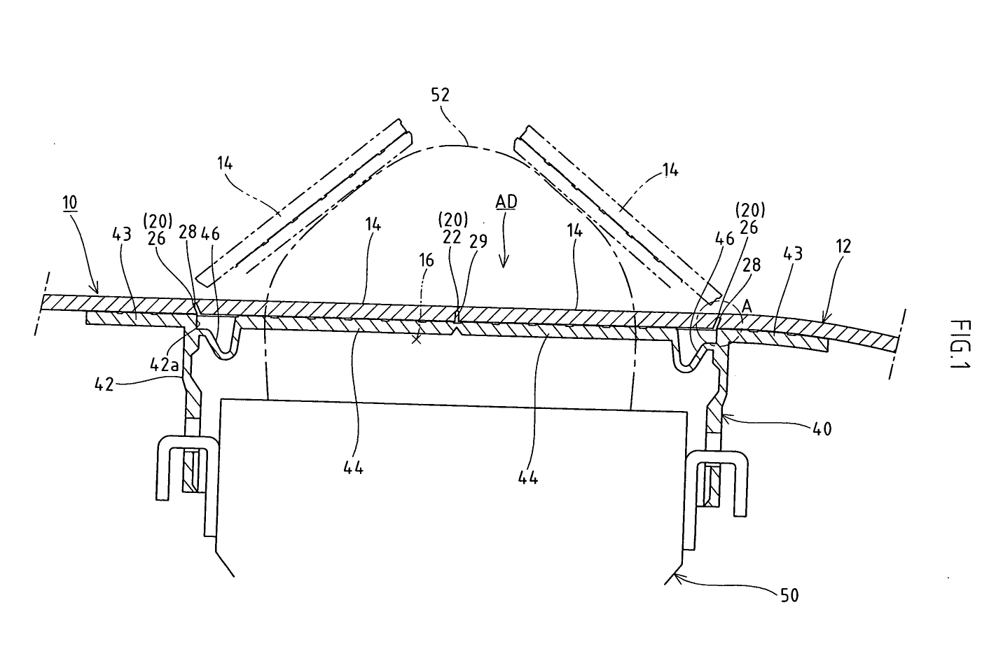

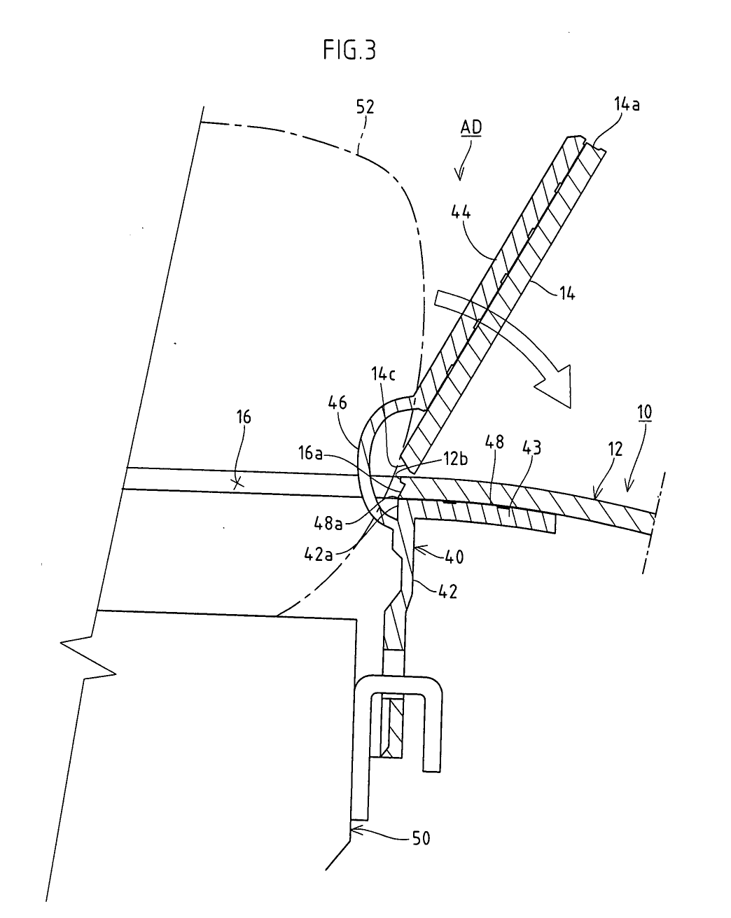

FIG. 1 shows an air bag door AD provided at an instrument panel 10 which is an interior part for a vehicle. The air bag door AD is a double-swing type having two door panels 14, 14 integrally formed at a base 12, and constitutes a part of the base 12. When an air bag apparatus 50 of the air bag door AD is activated to inflate an air bag 52, the pressure generated then breaks a predetermined break portion 20 provided at the base 12, the door panels 14, 14 are opened away from each other about respective proximal-end edges 14c (see FIG. 1 or FIG. 3). Groove portions 28, 29 which form the predetermined break portion 20 are open to the back side of the base 12 so that the predetermined break portion 20 cannot be seen from the cabin side facing the designed surface (face side).

In the air bag door AD, the face side of the door panels 14, 14 and the back side of the periphery of the air bag opening 16 formed in the base 12 when the door panels 14, 14 are opened are supported in a reinforcing manner by a backup member 40. The backup member 40 is formed of a synthetic resin into an approximately rectangular cylindrical shape. The backup member 40 includes (1) a cylindrical part 42 which supports the peripheral portion of the air bag opening 16 from the back, (2) door supports 44 which are formed inside the cylindrical part 42 to support the door panels 14, 14 from the back side of the door panel 14, and (3) hinge portions 46, 46 which connect the cylindrical part 42 to the door supports 44. The cylindrical part 42 has, at an upper end thereof, a flange 43 extending outward. With an opening portion 42a defined inside the flange 43 being surrounded in correspondence to the air bag opening 16, the flange 43 is attached to the base 12 by vibration welding, an adhesive or the like.

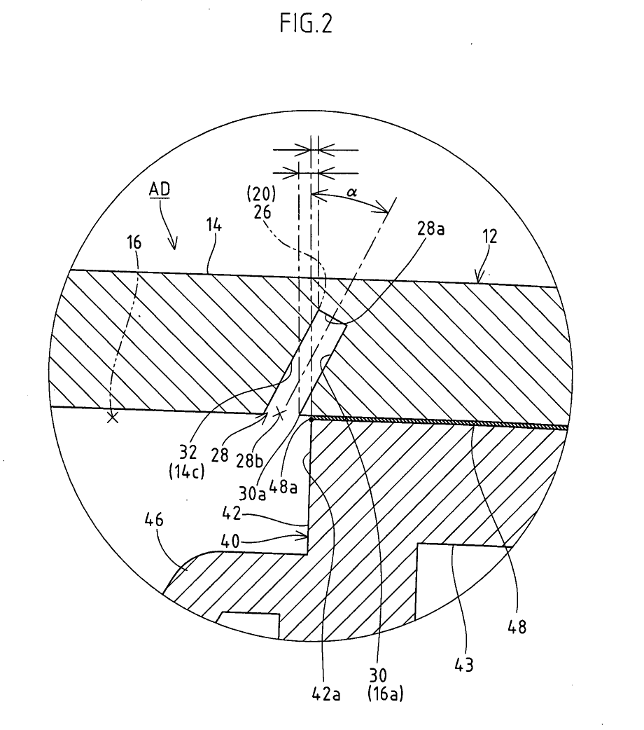

In the embodiment, an open end 28b of the groove portion 28 to be described later is provided at a position facing the opening portion 42a of the cylindrical part 42, and is not open to a position facing the flange 43 of the backup member 40. Accordingly, the cylindrical part 42 is fixed over the entire portion where the flange 43 faces the back side of the base 12, and the entire top surface of the flange 43 serves as a fixing portion 48 to the base 12 (see FIG. 2). The corner portion that is defined by the inner surface (opening portion 42a) of the cylindrical part 42 and the top surface of the flange 43 serves a door-panel side end portion (fixing end portion) 48a at the fixing portion 48. That is, the fixing end portion 48a is that end portion of the fixing portion 48 for the top surface of the flange 43 and the back side of the base 12 which is positioned closest to the door panel 14. By coupling the proximal-end edges 14c of each door panel 14 to the upper end portion of the cylindrical part 42 by the hinge portion 46 via the door support 44, the door panel 14 rotates around the hinge portion 46 when the air bag apparatus 50 is activated.

The base 12 is a relatively hard injection-molded member made of a synthetic resin material, for example, polypropylene (PP), AS or the like, and is molded according to the design of the instrument panel 10. The door panels 14, 14 constituting the air bag door AD are formed as a part of the base 12 at the same time as the base 12 is molded. Formed at contour lines of the door panels 14, 14 is the predetermined break portion 20 extending from distal-end edges 14a of the door panels 14, 14 around toward side-end edges 14b and extending along the proximal-end edges 14c in parallel. The predetermined break portion 20 is formed by cutting in the groove portions 28, 29 along the contour lines of the door panels 14, 14 by a rotary cutting tool, such as an end mill, and can be said to be a fragile portion formed by making the base 12 thinner.

The predetermined break portion 20 includes (1) a distal-end predetermined break portion 22 extending along the distal-end edge 14a of each door panel 14, (2) side-end predetermined break portions 24, 24 extending along the side-end edges 14b, 14b of each door panel 14, and (3) proximal-end predetermined break portions 26, 26 extending along the proximal-end edges 14c of the individual door panels 14. That is, the distal-end predetermined break portion 22 and the proximal-end predetermined break portions 26, 26 extend in a direction orthogonal to the opening direction of both approximately rectangular door panels 14, 14. The side-end predetermined break portions 24, 24 extend along the side-end edges 14b, 14b of each door panel 14 and in the opening direction of each door panel 14.

The first groove portion 28 which forms the side-end predetermined break portion 24 and the proximal-end predetermined break portion 26 is formed in such a way as to be inclined in an outer direction (hereinafter “outward”) away from the corresponding edges 14b and 14c of the door panel 14 along the base 12 as the first groove portion 28 extends toward a bottom portion 28a from the open end 28b (see FIG. 2). In the first groove portion 28, at least one side wall surface 30 defining the base 12 is formed obliquely so as to bias outward as the side wall surface 30 extends toward the bottom portion 28a from the open end 28b. By way of contrast, the second groove portion 29 which forms the distal-end predetermined break portion 22 is formed in a direction normal to the base 12 (see FIG. 1). That is, of the groove portions 28, 29 which form the predetermined break portion 20, the first groove portion 28 provided contiguous to the boundary between the door panel 14 and the base 12 is recessed obliquely with respect to the normal direction of the base 12, whereas the second groove portion 29 provided contiguous to the boundary between the adjoining door panels 14, 14 is formed in an adequate direction (formed in the normal direction in the embodiment).

As shown in FIG. 2, the first groove portion 28 is so formed as to be inclined outward, so that the predetermined break portions 24, 26 provided at the bottom portion 28a of the first groove portion 28 are positioned outward of the base-side corner portion 30a of the open end 28b. Here, the base-side corner portion 30a is the corner portion defined by one side wall surface 30 of the first groove portion 28 and the back side of the base 12. The bottom portion 28a of the first groove portion 28 is formed askew to the corresponding face side of the base 12. This minimizes the thickness of that portion of the first groove portion 28 which remains on the base 12 at either the corner portion defined by one side wall surface 30 and the bottom portion 28a or the corner portion defined by the other side wall surface 32 and the bottom portion 28a. The predetermined break portions 24, 26 are provided at this corner portion where the thickness of the remaining portion becomes minimum. In the embodiment, the bottom portion 28a is inclined away from the open end 28b as the bottom portion 28a extends from one side wall surface 30 which defines the side of the base 12 toward the other side wall surface 32 which defines the side of the door panel 14. Accordingly, the side-end predetermined break portion 24 and the proximal-end predetermined break portion 26 are set at the corner portion defined by the other side wall surface 32 and the bottom portion 28a.

The first groove portion 28 in the embodiment is formed in such a way that one side wall surface 30 to be the opening edge 16a of the air bag opening 16 and the other side wall surface 32 to be the peripheral edge (side-end edge 14b, proximal-end edge 14c) of the door panel 14 are both inclined outward as they extend from the open end 28b toward the bottom portion 28a. The first groove portion 28 extends with one side wall surface 30 and the other side wall surface 32 set apart by a given gap in parallel, and the bottom portion 28a is formed approximately flat.

As one side wall surface 30 of the first groove portion 28 is formed in such a way as to be inclined outward as the side wall surface 30 extends from the open end 28b toward the bottom portion 28a, the opening edge 16a of the air bag opening 16 can also be inclined outward as the opening edge 16a extends from the back side of the base 12 toward the face side thereof which is the inflating direction of the air bag (see FIG. 3).

Because the side-end predetermined break portion 24 and the proximal-end predetermined break portion 26 are provided in such a way as to be positioned outward of the base-side corner portion 30a of the open end 28b of the first groove portion 28, the break surface 12b on the base 12 side that is produced by the breakage at the predetermined break portions 24, 26 is positioned outward of the opening edge 16a of the air bag opening 16. That is, at the time of inflating the air bag 52, the opening edge 16a of the air bag opening 16 and the break surface 12b on the base 12 side can be prevented from contacting the air bag 52, thus ensuring smooth inflation of the air bag 52.

As the first groove portion 28 is formed to be inclined outward, the bottom portion 28a is provided on the backup member 40 side. Accordingly, the side-end predetermined break portion 24 and the proximal-end predetermined break portion 26 which become the point of action when the door panel 14 is opened can be made closer to the point of support of the fixing portion 48 (fixing end portion 48a in the embodiment) which fixes the base 12 to the backup member 40 (see FIG. 2). That is, when pressure is applied to the door panels 14 according to the inflation of the air bag 52 caused by the activation of the air bag apparatus 50, the side-end predetermined break portion 24 and the proximal-end predetermined break portion 26 can be broken with small force at the portion to be the point of support according to the principle. It is also possible to suppress dispersion of stress to be applied to the bottom portion 28a of the first groove portion 28. Accordingly, each door panel 14 is smoothly opened to a desired open angle adequately.

The first groove portion 28 is formed in such a way that the predetermined break portions 24, 26 are positioned at the same position as or outward of the fixing end portion 48a of the fixing portion 48 (see FIG. 2). Further, the open end 28b of the first groove portion 28 is formed at the position facing inside the opening portion 42a of the cylindrical part 42, and is set in such a way that the opening end of one side wall surface 30 is aligned with or positioned close to the fixing end portion 48a. As the bottom portion 28a of the first groove portion 28 is formed at the position facing the fixing portion 48, the open end 28b can be provided near the fixing end portion 48a. As mentioned above, the predetermined break portions 24, 26 to be the point of action can be made closer to the fixing end portion 48a to be the point of support.

Further, that portion of the base 12 which corresponds to the first groove portion 28 is supported by the flange 43 of the backup member 40 from the back side. Therefore, reduction in strength caused by the formation of the first groove portion 28 can be compensated for by the backup member 40, thus making it possible to keep the overall strength needed. What is more, that portion of the back side of the base 12 which corresponds to the first groove portion 28 is the fixing portion 48 fixed to the flange 43, so that the peripheral portion of the air bag opening 16 is held by the flange 43 at the time of opening the door panels 14. This makes it possible to suppress deformation of the peripheral portion of the air bag opening 16.

The air bag door AD of the embodiment, as apparent from the above, can suppress dispersion of stress originated from opening of the door panels 14. In addition, as stress is concentrated on the predetermined break portions 24, 26, the base 12 is adequately broken at the predetermined break portions 24, 26, thereby minimizing the energy needed for breaking the base 12. This can permit smooth opening of the door panels 14.

The first groove portion 28 has one side wall surface 30 formed inclined and has the bottom portion 28a also formed inclined toward the open end 28b as the bottom portion 28a extends outward from the other side wall surfaces 32. That is, the pointed corner portion defined by the other side wall surfaces 32 and the bottom portion 28a faces in the normal direction of the base 12, and the thickness of the remaining portion from that corner portion to the face side of the base 12 is minimized (see FIG. 2). When pressure from the air bag 52 is applied to the door panels 14, therefore, stress is concentrated on the side-end predetermined break portion 24 or the proximal-end predetermined break portion 26 set at the corner portion of the first groove portion 28, the fragile portion of the base 12 is adequately broken along the predetermined break portion 24, 26. This can suppress the actual break line from being deviated from the side-end predetermined break portion 24 and the proximal-end predetermined break portion 26. The air bag door AD can reduce the energy needed to break the base 12 and can reduce projections, such as burrs, remaining on the air bag opening 16 or the edges 14b, 14c, 16a of the door panel 14.

It is preferable to set the inclination angle α of the first groove portion 28 within a range of 5° to 45° with respect to the normal direction of the base 12. If the inclination angle cc of the first groove portion 28 becomes less than 5°, it becomes difficult to configure the predetermined break portions 24, 26 provided at the bottom portion 28a to be positioned outward of the base-side corner portion 30a of the open end 28b. It is also difficult to position the predetermined break portions 24, 26 at the same position as or outward of the fixing end portion 48a at the fixing portion 48 for the base 12 and the backup member 40. If the inclination angle a of the first groove portion 28 becomes greater than 45°, the first groove portion 28 becomes deeper, leading to a reduced strength. Further, the base 12 between one side wall surface 30 and the back side becomes thinner, so that when the base 12 is fixed to the flange 43 of the backup member 40, the desired strength may not be provided.

The first groove portion 28 can be formed easily by cutting in the base 12 with, for example, an end mill inclined. Apparently, the corner portions of the first groove portion 28 can be formed to have an approximately V shape using an ordinary end mill without using a specially-shaped cutting tool. That is, because a cutting tool as an expendable is itself inexpensive, the overall running cost can be suppressed. Forming the bottom portion 28a of the first groove portion 28 flat can make it easier to control the cutting depth of the first groove portion 28 with the cutting tool.

The present invention explained so far is summarized below.

In an air bag door having a groove portion of a predetermined depth serving as a predetermined break portion provided and extending at the peripheral edge of the door panel, provided at the base of an interior part for a vehicle, a reinforcing member is fixed to the back side of the base at that portion which surrounds the door panel,

the groove portion extending at a boundary between the door panel and the base has side wall surfaces defining a base side obliquely formed in such a way as to come away outward from the door panel as the groove portion extends from an open end side at a back side of the base towards a closed end, and

the predetermined break portion provided at the closed end is positioned at the same position as or outward in the normal direction of the base with respect to the door-panel side end portion of the fixing portion which fixes the reinforcing member to the base.

### (Modification)

The above-described embodiment can be modified as follows.
(1) Although the foregoing description of the embodiment has been given of a double-swing type air bag door having two door panels by way of an example, the invention may be adapted to a one-swing type having a single door panel, four-way swing type having four door panels, or the like.
(2) Although the foregoing description of the embodiment has been given of a base-integral type air bag door wherein the door panels are formed integral with the base to normally serve as a part of the base, the invention may be adapted to a base-separated type air bag door which has door panels formed separate from the base and assembled to the base in a later process.

The air bag door according to the present invention can efficiently break the base at the predetermined break portion. In addition, it is possible to prevent the break surface of the base from contacting the air bag.

What is claimed is:

1. An air bag door comprising:
a base of an interior part for a vehicle;
a door panel provided at the base; and
a groove portion of a predetermined depth serving as a predetermined break portion provided and extending at a peripheral edge of the door panel,
wherein the groove portion extending at a boundary between the door panel and the base has side wall surfaces defining a base side obliquely formed in such a way as to come away outward from the door panel as the groove portion extends from an open end side at a back side of the base towards a closed end, and
the predetermined break portion provided at the closed end is configured so as to be positioned outward of a base-side corner portion of the open end.

2. The air bag door according to claim 1, wherein the predetermined break portion is positioned at a same position as or outward of a door-panel side end portion of a fixing portion which fixes the base and a reinforcing member surrounding the door panel at the back side of the base.

3. The air bag door according to claim 1, wherein the closed end of the groove portion obliquely extends with respect to a corresponding portion at a face side of the door panel.

4. The air bag door according to claim 1, wherein the side wall surfaces defining the base side of the groove portion are inclined within a range of 50 to 45° with respect to a normal line of the base.
